(19) United States
(12) Patent Application Publication
(10) Pub. No.: US 2019/0082713 A1
(43) Pub. Date: Mar. 21, 2019

(54) Use of chocolate

(71) Applicant: David W. Little, Livingston, NJ (US)

(72) Inventor: David W. Little, Livingston, NJ (US)

(21) Appl. No.: 15/732,318

(22) Filed: Oct. 24, 2017

Related U.S. Application Data
(60) Provisional application No. 62/560,875, filed on Sep. 20, 2017.

(51) Int. Cl. A23G 1/50

(52) U.S. Cl. CPC A23G 1/50; A23V 2002/00

(57) ABSTRACT

Embodiments of the present invention comprise customized chocolates, chocolate messages, customized food storage containers, and pieces of chocolate for use in conjunction with beverage and drinking glasses and for use with board games.

### CROSS-REFERENCES TO RELATED APPLICATIONS

This application claims the benefit of:

(1) U.S. Provisional Application For Patent, Ser. No.: 62/411,038, filed Oct. 21, 2016; and

(2) U.S. Provisional Application For Patent, Ser. No.: 62/560,875, filed Sep. 20, 2017;

and whose contents are incorporated by reference herein in their entirety.

### FIELD OF THE INVENTION

Embodiments of the present invention comprise various uses of pieces of chocolate. More specifically, embodiments of this invention comprise customized chocolates, chocolate messages, customized food storage containers, and pieces of chocolate for use in conjunction with beverage and drinking glasses and for use with board games.

### BACKGROUND OF THE INVENTION

Individual or custom-made designs from chocolate are well known in the prior art. It is common to create a chocolate design by molding a block of chocolate. Alternatively, quantities of chocolate made by melting and pouring into a custom-shaped mold, and then hardened into the shapes of the mold.

These prior art methods have at least one major drawback. They are very labor intensive. It takes a lot of time, effort, and expense to individually carve a block of chocolate to a desired shape. Similarly, it takes a lot of time, effort, and expense to make a custom-shaped mold.

This drawback is especially significant when one desires to create a message or design containing letters, numbers, symbols, and/or custom-made icon shapes in a chosen font. For example, one may want to send a message in chocolate saying “Happy 50^{th} Birthday” or “I Love You”. Similarly, one may want to celebrate a sporting event by distributing a chocolate memento to many friends and fans.

In the prior art, such undertakings may take hours, days, and sometimes weeks to complete. First, one large custom mold containing all letters and graphics needs to be made for each instance. Then, the chocolate is molded in that mold. For example, the chocolate candy bars made by the Nestle Company is made in one very large mold containing all the letters “N-E-S-T-L-E” and a raised border around the edge. In fact, such an individual message or design may be cost prohibitive to custom make.

Further, fulfilling the desire for sweet treats such as chocolate are often a last minute, impulsive act. In the prior art, the time and cost of preparing such customized chocolate messages and designs would typically be prohibitive.

Another method of customizing individual chocolate pieces is to include graphics on the wrappers of individual chocolate pieces. In the prior art, this result is typically accomplished by manually decorating each individual chocolate wrapper using paint, markers, or other well-known artistic techniques. Then, each decorated wrapper is placed around a piece of chocolate.

This process can be slow, tedious, and very labor intensive. Further, the process is not economically feasible for single or other very small quantities of chocolate pieces.

In addition to customizing chocolates, one often desires to include graphics on individual food storage containers, such as metal or plastic tins which hold chocolates, candies, dried fruit, or baked goods. In the prior art, this goal is typically accomplished by manually decorating each individual container using paint, markers, or other well-known artistic techniques. Then, each decorated container is filled with the contents of choice or stored for future use.

Similar to adding graphics to chocolate wrappers, this process can be slow, tedious, and very labor intensive.

Thus, it is desired to have a method and system for creating customized, chocolates messages, chocolate designs, individual chocolates, and food containers more quickly and economically than what is possible in the prior art.

Further, the prior art lacks utilizing chocolate pieces in a dynamic manner. For example, it is desired to have specially designed, edible chocolate pieces that are made to accompany and/or fit on most drinking glasses as an accompaniment to an alcohol or non-alcoholic drink. It is also desired that individual, different pieces may be combined thematically into sets to accomplish, or provide influence towards, a specified goal or purpose.

Thus, it is desired to have items, methods, and systems using chocolate which overcome these prior art limitations and which accomplish the above objectives and goals.

### BRIEF SUMMARY OF THE INVENTION

Objects of the present invention include overcoming the prior art limitations described above.

Embodiments of the present invention comprise customized chocolates, chocolate messages, customized food storage containers, and pieces of chocolate for use in conjunction with beverage and drinking glasses and for use with board games.

### BRIEF DESCRIPTION OF THE SEVERAL VIEWS OF THE DRAWING

FIG. 1 illustrates an embodiment of this invention showing various customized chocolate pieces.

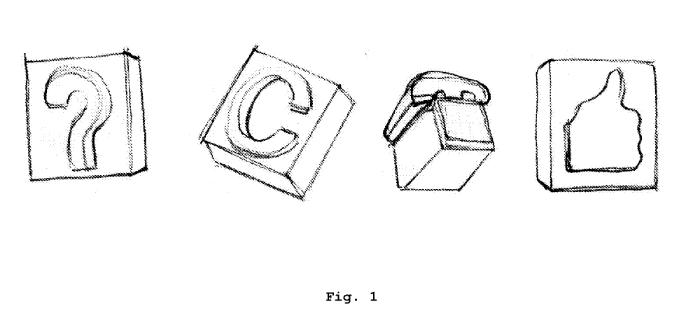

FIG. 2 illustrates an embodiment of this invention showing a sample message composed of customized chocolate pieces.

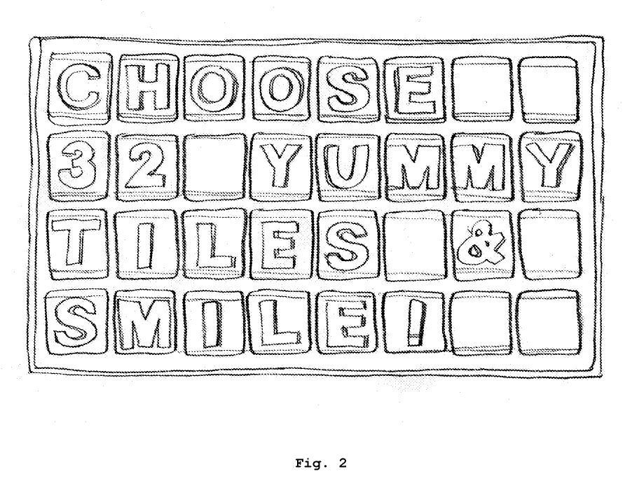

FIG. 3 illustrates an embodiment of this invention showing chocolate pieces with customized wrapping.

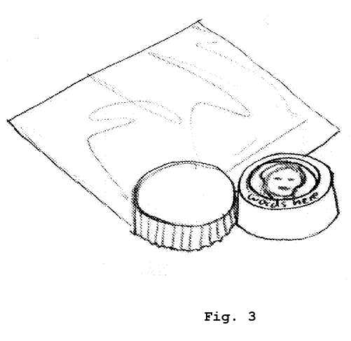

FIG. 4 illustrates an embodiment of this invention showing customized container to hold chocolate.

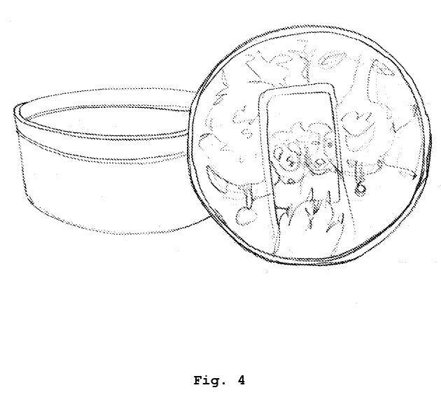

FIG. 5 illustrates an embodiment of this invention showing chocolate pieces in the shape of wedges for placement on the rim of a beverage glass.

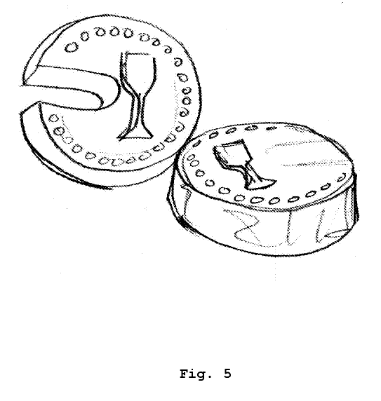

FIG. 6 illustrates an embodiment of this invention showing chocolate pieces for placement near a beverage glass.

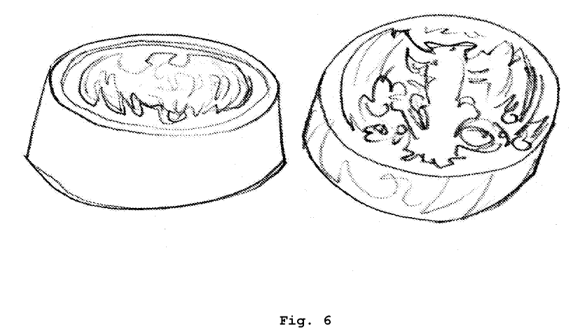

FIG. 7 illustrates an embodiment of this invention showing a chocolate piece placed on the rim of a beverage glass.

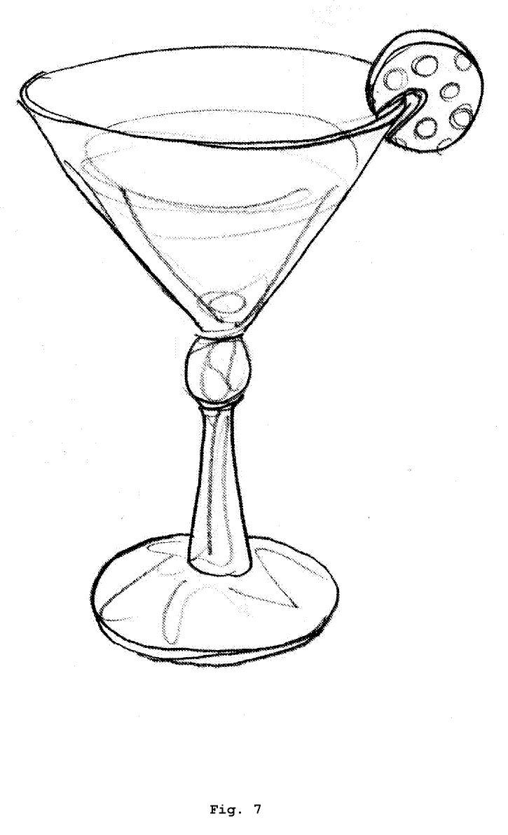

FIG. 8 illustrates an embodiment of this invention showing s chocolate piece with an indicia placed on the rim of a beverage glass.

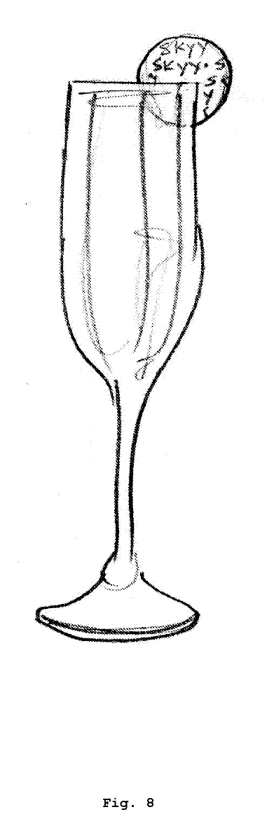

FIG. 9 illustrates an embodiment of this invention showing a series of chocolate pieces for placement on the rim of or near a beverage glass with indicia related to the amount of alcohol consumed by a patron using the glass.

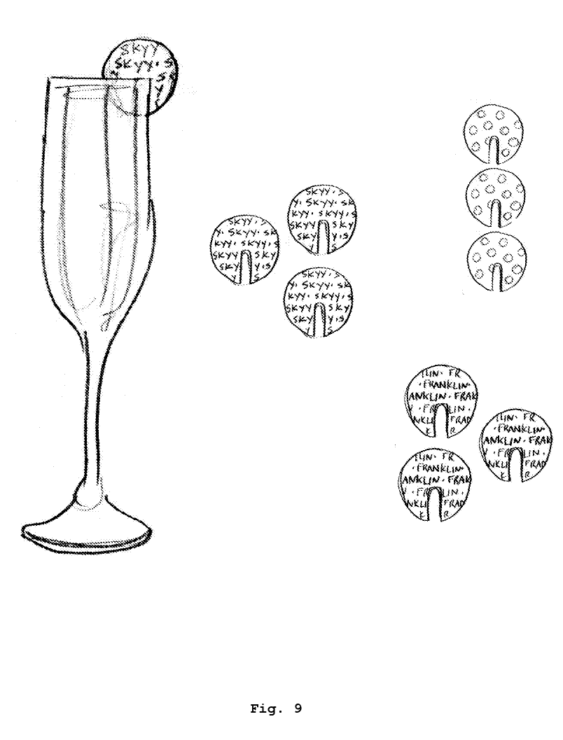

FIG. 10 illustrates an embodiment of this invention showing various board games using customized pieces of chocolate.

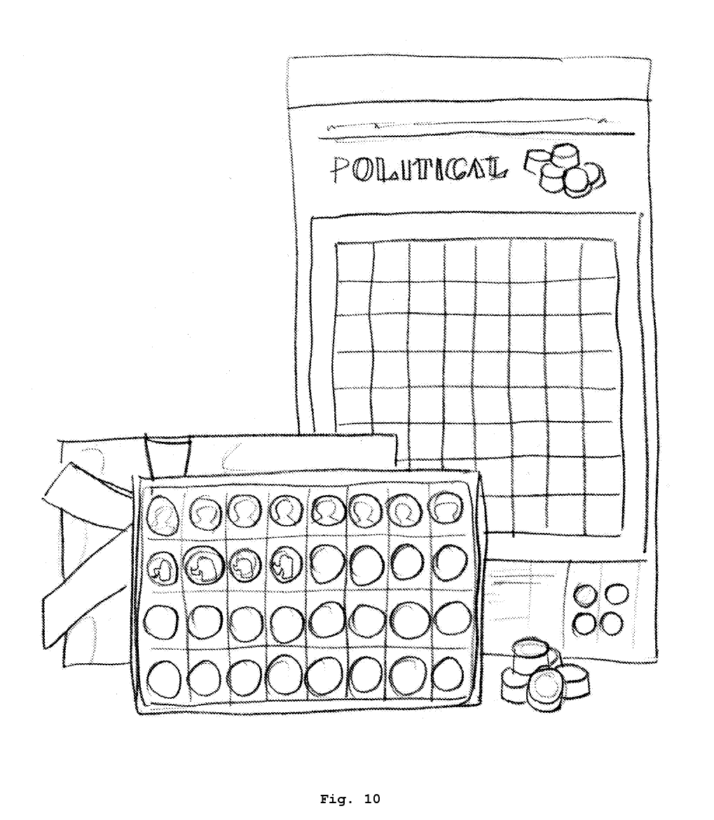

### DETAILED DESCRIPTION OF THE INVENTION

Embodiments of this invention comprise a mass marketable, cost effective, efficient, and expandable system, for creating customized messages and designs from chocolate. The customized messages and designs may be provided by the customers themselves, one at a time, preferably over the internet via a website or other means known in the relevant art. Preferably, more than 100 letters, symbols, emojis, and other characters are available for the customer to choose.

Preferably, the customer does all the design work.

The system comprises a collection of individual chocolate pieces (“characters”) shaped into various letters, numbers, symbols, and other desired designs. The characters are preferably made by hardening chocolate in multiple molds for each of the desired shapes and then removing and storing the individual characters. These characters are then held in inventory until needed.

Preferably, all the characters are the same size (length, width, and weight). However, embodiments of this invention accommodate different sized characters.

For example, in one embodiment of this invention, the characters may include emoji- or emoticon-shaped chocolate pieces. Emojis and emoticons are images or icons commonly used in digital communication to graphically express an emotion or idea. These emoji or emoticon characters may have the shape of other characters in the set. Alternatively, they may have their own individuals shapes which are smaller than the other characters.

Further, in another embodiment of this invention, the characters may include sidecar-shaped chocolate pieces. Sidecars are specially designed, edible chocolate pieces that are made to fit on most drinking glasses as an accompaniment to an alcohol or non-alcoholic drink. These sidecar characters may have the shape of other characters in the set. Alternatively, they may have their own individuals shapes which are smaller than the other characters.

In use, to create a specific message or design, the operator takes from inventory the characters required to construct the message or design. Also, any non-inventoried shapes and icon symbols that are needed are created prior to construction.

The selected characters are then placed onto a grid in the order necessary to construct the desired message or design. Preferably, the grid comprises individual cubicles surrounded by “walls” to keep the chocolate characters from moving around and out of proper alignment.

Because the system utilizes pre-existing individual chocolate characters, one may construct simple and/or complex messages and designs efficiently, quickly, and economically. The messages and designs may include numbers and letters/symbols from any language.

Embodiments of this invention include without limitation:
(a) Grids in the shape of a gift box. These box may be of varying sizes to contain messages of varying length. For example, the boxes may hold up to:
   (1) six characters (1×6);
   (2) fifteen characters (3×5);
   (3) twenty-four characters (4×6);
   (4) twenty-eight characters (4×7);
   (5) thirty-two characters (4×8); or
   (6) forty-eight characters (6×8).
   The boxes may also be custom designed.
(b) The boxes described in (a) above may also be decorated with ribbons or other printed material which is customized to the message inside or as otherwise desired by the purchaser.
(c) Grids in the shape of crossword puzzles. These puzzles may be standard or customized/designed by the purchaser. In this embodiment all the crossword squares may be chocolate characters. Alternatively only some of the crossword squares are chocolate, and the remaining squares are printed on the grid. For this embodiment, the chocolate used is preferably of differing colors to highlight the structure of the crossword puzzle or a message or design contained within the puzzle.
(d) Chocolate characters containing medical marijuana of prescribed dosage, optionally made into messages or designs, or indicating when they should be consumed (analogous to a “pill box”).
(e) Chocolate messages and designs packaged with greeting cards on other greetings for birthdays, holidays, corporate events, and other appropriate events.
(f) Chocolate messages and designs distributed in conjunction with sporting events, which optionally may be customized to promote a favorite team.
(g) Chocolate messages and designs matched with gifts for weddings and other celebrations. For example, the chocolate message or design may be combined with fine linen and towels (optionally monogrammed) as a wedding gift.
(h) Advertisements for products, services, website names, and URLs done in chocolate text. Such advertisements can be mass distributed.
(i) Text messages memorialized in chocolate text.
(j) Internet search results in chocolate text.
(k) Newspaper or magazine inserts composed of chocolate text.

The chocolate message or design or gift box may also be decorated as desired, either with edible or non-edible items.

In short, the chocolate message or design is ready for use, with much less time and effort than the prior art methods. Also, this invention allows for a greater variety of chocolate messages and designs within realistic economic constraints.

Thus, with this invention, customized messages, designs, and novelty items may be made out of chocolate economically and rapidly.

Another embodiment of this invention comprises taking individual photographs or other graphics and reproducing them on stickers and attaching them to individual chocolate wrappers and tins.

Preferably, the graphics are uploaded via the internet to a central processing facility using methods well-known in the prior art. Alternatively, the graphics may be hand delivered or sent by mail or courier to the processing facility.

The graphics are then reproduced on the desired number of stickers (which is appropriately sized to fit on a wrapper) by printing or using other methods well-known in the prior art. Subsequently, each sticker is attached to a wrappers for an individual piece of chocolate by adhering methods well-known in the prior art.

The graphics may have images of politicians, political candidates, elected government officials, and political party symbols. The wrapped chocolates may be grouped together to include competing candidates for a particular political election, all members of a particular governmental body, or other similar groupings.

In another embodiment, these groups of wrapped chocolates comprise a game to follow political campaigns and elections, to learn about the governmental structure of a jurisdiction (city, state, country, etc.), or to provide other educational activities related to learning about politics.

Still another embodiment of this invention taking a photograph or other graphic and reproducing it on a sticker and attaching it to a food container or tin.

Preferably, the graphic is uploaded via the internet to a central processing facility using methods well-known in the prior art. Alternatively, the graphic may be hand delivered or sent by mail or courier to the processing facility.

The graphic is then reproduced on a sticker (which is appropriately sized to fit on a container or tin) by printing or using other methods well-known in the prior art. Subsequently, the sticker is attached to a container or tin by adhering methods well-known in the prior art. Then, the decorated container is filled with the contents of choice or stored for future use.

Finally, a ribbon or other trimming may be added to the decorated container or tin.

These graphics may be used to record any special event, memory, or passion.

Other embodiments of this invention may be used to provide information about an individual through one or more specially designed pieces of chocolate. Also, an individual's behavior may be incentivized or motivated through one or more specially designed pieces of chocolate.

Embodiments of this invention comprise specially designed, edible chocolate pieces that are made to fit on most drinking glasses as an accompaniment to an alcohol or non-alcoholic drink.

Each individual piece is made from solid chocolate. Embodiments of the invention are made from either dark or milk chocolate. Alternatively, embodiments of the invention are made from flavored chocolate {e.g., strawberry-flavored].

The piece is preferably made by molding chocolate into various custom designed molds. However, the piece may be alternatively made by any appropriate chocolate production method well known in the prior art.

A typical size for the piece is approximately 1 3/16″ top×1⅜″ bottom×½″ high]. A typical weight for the piece is approximately ½ oz.

Within the piece is an open area shaped like a wedge. The wedge is large enough to be placed easily over the rim of a drinking glass and to sit on the rim, but not to fit excessively loosely on the rim.

Embodiments of the invention are designed into various shapes (e.g., an olive). Optionally, the shape and size may be coordinated with the beverage(s) to which it is planned to attach the piece.

Further, optionally, the chocolate pieces may be custom branded by a special mold or imprinted utilizing methods well known in the prior art.

In use, the wedge of chocolate piece is placed over the rim of a beverage or drinking glass. A portion of the wedge contacts the rim. The piece then stays on the rim by the actions of friction at the contact area and/or gravity on the piece itself.

The piece is then removed from the glass as desired and may be consumed or used as otherwise desired.

In other embodiments of this invention, individual or sets of the chocolate wedges may have a common theme.

One such embodiment is aimed specifically at the restaurant, bar, and nightclub as a novel way to help reduce drunk driving. In this embodiment, a wedge is placed on the side of an alcohol filled glass. Now the establishment/bartender is able to monitor the progress of certain patrons who may need assistance in getting home safely and otherwise should not be driving a vehicle.

Even just a single piece of chocolate may be used to show if a patron has drunk too much for his/her own health or to be able to drive safely.

Regardless of how many pieces of chocolate are utilized in this process, the chocolate is used to warn both patron and management about, and to monitor unsafe amounts of alcohol consumption.

Preferably, a set of three (3) chocolate wedges are available in three (3) colors and/or flavors (e.g., Milk, Dark, and White). Each wedge is imprinted with the name of the establishment, sponsor, or a uniform print message such as “CS4S”. Each color will signify to the bartender/establishment a message related to an individual's current alcoholic consumption.

Preferable use is as follows: If/when a patron start to drink heavily (e.g., 4-5 drinks in a short period), the bartender puts a dark chocolate side car on this drink and notes that the patron is encouraged to keep it in place.

When this patron orders additional drinks (e.g., two or more), he gets a milk chocolate wedge imprinted with the same message and can consume/discard/share the first wedge.

If the same patron drinks more or is obviously under the influence, he gets a white chocolate wedge (and again may consume/discard/share the previous wedge) and is informed that he will need to find alternative transportation home.

This use of different colored wedges is a subtle way to allow multiple bartenders to note which patrons have consumed enough beverages to be monitored and aids the establishment in trying a concerted effort to reduce drunk driving. It also is an understated way to let the patron know he might be having too many drinks.

The chocolate wedge may be further customized by an establishment or sponsor's brand and is available packed bulk or in gift boxes for consumer gifting. There are “Designated Driver” imprinted wedges available also for designing a program around them. They are also available are a variety of stock designs for multiple sports and occasions.

In other embodiments of this invention, chocolate pieces are used for board games. For example, chess and checkers boards are reconfigured to be competition between opposing political spectrums, and the pieces are personalized with images of today's political party and government figures. Placement instruction for the pieces are included on the customized game boards. [currently, just the foil wrapper is different; in the future, the actual chocolate pieces could be different

In one such embodiment, the board has opposite edges, one red and one blue; in between these edges, these colors morph into purple (which is the combination of red and blue). Being that in the United States today, Republicans are often represented by the color “red” and Democrats are often represented by the color “blue”, the pieces at the “red” side may be Republican figures, and the pieces at the “blue” side may be Democratic figures.

Although this invention has been described with a certain degree of particularity, it is to be understood that the present disclosure (including, without limitation, all drawing pages) has been made only by way of illustration, and that numerous changes in the details of the system, apparatus, and/or method may be resorted to without departing from the spirit and scope of the invention.

For example, uploaded or otherwise obtained images may be placed directly on chocolate, a chocolate mask (2D or 3D) of an individual may be created from 1 or more images utilizing a series of 360 degree image technology or otherwise of a subject, or pictures may be reproduced on chocolate.

Also, one may can put customized letters or images onto chocolate pieces.

What is claimed is:

1. A piece of chocolate comprising an indicia, the indicia representing a characteristic of a recipient of the chocolate piece.

2. A method of a utilization of chocolate regarding a person, the method comprising the steps of:
(a) obtaining a piece of chocolate comprising an indicia, the indicia representing the utilization; and
(b) locating the chocolate piece near the person.

3. The method as described in claim 2, wherein the utilization comprises representing a characteristic of the person.

4. The method as described in claim 2, wherein the utilization comprises promoting a behavior of the person.

5. A piece of chocolate comprising a groove, the groove sized to fit over a rim of a beverage glass.
